(19) United States
(12) Patent Application Publication
(10) Pub. No.: US 2025/0366474 A1
(43) Pub. Date: Dec. 4, 2025

(54) USE OF 4,5-DIMETHYLTHIAZOLE IN PROMOTING PLANT GROWTH

(71) Applicant: HUAZHONG AGRICULTURAL UNIVERSITY, Wuhan City (CN)

(72) Inventors: Tao Ren, Wuhan City (CN); Yating Fang, Wuhan City (CN); Jianwei Lu, wuhan City (CN); Siyao Du, Wuhan City (CN); Jing Xu, Wuhan City (CN); Yangyang Zhang, Wuhan City (CN); Shipeng Liao, Wuhan City (CN); Xiaokun Li, Wuhan City (CN); Rihuan Cong, Wuhan City (CN); Zhifeng Lu, Wuhan City (CN)

(21) Appl. No.: 19/221,541

(22) Filed: May 29, 2025

(30) Foreign Application Priority Data
May 30, 2024 (CN) 202410693453.0

(51) Int. Cl. A01N 43/78; A01P 21/00

(52) U.S. Cl. CPC A01N 43/78; A01P 21/00

(57) ABSTRACT

The present disclosure belongs to the technical field of agriculture, and specifically discloses use of compound 4,5-dimethylthiazole in promoting plant growth. The present disclosure proposes for the first time that 4,5-dimethylthiazole has biostimulants functions, and use for rice seed soaking, seedling root drenching and seedling hydroponics can significantly improve rice seed germination, promote root system growth of rice seedlings, increase the chlorophyll content of rice seedling leaves, and elevate nitrogen uptake and total biomass of rice seedlings.

### CROSS-REFERENCE TO RELATED APPLICATIONS

The present disclosure claims the priority to Chinese patent application with the filing No. 202410693453.0 filed on May 30, 2024 with the China National Intellectual Property Administration, and entitled “USE OF 4,5-DIMETHYLTHIAZOLE IN PROMOTING PLANT GROWTH”, the contents of which are incorporated herein by reference in entirety.

### TECHNICAL FIELD

The present disclosure belongs to the technical field of agriculture, and specifically to use of 4,5-dimethylthiazole in promoting plant growth.

### BACKGROUND ART

“Healthy and strong seedlings ensure bountiful harvest and high yield”. Cultivation of strong rice seedlings ensures high and stable yield of rice. Well-developed roots, broad and flat caudex, dark green leaves, and many tillers are markers of robust rice seedlings. In order to cultivate strong seedlings, previous generations have explored numerous techniques across various stages from rice seed treatment to seedling cultivation. For example, seed coating agents and seed dressing agents are used during the rice seed treatment to enhance seedling resistance, density is controlled through sparse and even planting during rice seed sowing to strengthen root development capability of seedlings, plant growth regulators are applied in seedlings cultivation processes to improve stem hardness, control spindling of stems and leaves, and reduce seedling height so as to cultivate stocky seedlings, etc. In practical production, natural environmental conditions of seedbeds are often subject to temporal and spatial constraints. In order to ensure seedling quality, famers often apply excessive chemical fertilizers, resulting in vigorous seedling growth but poor root system development, and affecting rice rooting and tillering, and excessive pesticide application causes seedling chlorosis and death. Therefore, rational use of seed dressing agents or seedling strengthening agents that integrate nutrition, disinfection and chemical regulation is the most convenient and cost-effective measure for cultivating sound seedlings.

Biostimulants are one or more compound substances or microorganisms independent from fertilizers and pesticides, and improving plant nutritional efficiency, abiotic stress tolerance or crop quality trait. Biostimulants are mainly derived from animal and plant extracts and microbial preparations, including humic acid and fulvic acid, seaweed extracts and plant preparations, free proteins and other nitrogen-containing compounds, chitin and chitosan, beneficial bacteria, etc. During research and preparation of biostimulants, effective ingredients of extracts are often unclear, thus requiring significant time and substantial economic costs. Therefore, excavating and rationally applying effective ingredients of plant extract biostimulants are one of the important approaches for promoting agricultural production development featured by efficient resource utilization and friendly ecological environment.

Thiazole-based compounds contain an important five-membered heteroaromatic ring containing nitrogen and sulfur heteroatoms. Special structure of thiazole-based compounds enables them to have great development value in many fields such as chemistry, pharmacy, biology and material sciences. In the agricultural field, research and development and application of thiazole pesticides is extremely active, for example, as herbicides, fungicides and insecticides. Moreover, thiazole-based compounds, as plant growth regulators, have advantages such as low pesticide residue rate, harmless to humans and livestock and environmentally friendliness. Thidiazuron, forchlorfenuron and fluthiacet-methyl are currently known thiazole-based plant growth regulators for production, and whether there are other thiazole-based biostimulants needs to be explored urgently. We have screened 4,5-dimethylthiazole from rapeseed metabolites, and found that it has a function of promoting rice growth. Therefore, further exploration and utilization of 4,5-dimethylthiazole biostimulant effects can provide a reference for rice seedling management and cultivation techniques.

### SUMMARY

In order to solve the above problem, the present disclosure provides new use of 4,5-dimethylthiazole as a biostimulants for promoting plant growth.

In order to achieve the above objective, the present disclosure adopts technical solutions as follows.

Use of 4,5-dimethylthiazole in promoting plant (e.g., rice) growth is provided.

In one aspect, 4,5-dimethylthiazole is used as a rice seed soaking agent at a concentration of 50-200 mg/L (preferably 50 mg/L). Compared with water seed soaking, seed soaking with 4,5-dimethylthiazole can improve biomass of shoot parts and root system of rice, total biomass and total leaf chlorophyll content.

In another aspect, 4,5-dimethylthiazole is used as a rice root irrigation solution at a concentration of 50-200 mg/L, which can improve biomass of shoot parts and root system of rice, total biomass and total leaf chlorophyll content.

In still another aspect, 4,5-dimethylthiazole is used as a rice hydroponic additive at a concentration of 5-50 mg/L, which can elevate a dry matter mass of stems and leaves of rice, a dry matter mass of root system and a total dry matter mass, increase a rice plant height, a leaf area and total root count, and promote nitrogen accumulation in the root system, stems and leaves of rice.

Compared with the prior art, the present disclosure has the following beneficial effects.

1. The present disclosure proposes for the first time that 4,5-dimethylthiazole has biostimulants functions.

2. 4,5-dimethylthiazole is formulated into a solution in the present disclosure, for rice seed soaking, seedling root drenching and seedling hydroponics, and can significantly improve rice seed germination, promote root system growth of rice seedlings, increase the chlorophyll content of rice seedling leaves, and elevate nitrogen uptake and total biomass of rice seedlings.

### BRIEF DESCRIPTION OF DRAWINGS

FIG. 1 shows the chemical structural formula of 4,5-dimethylthiazole.

FIG. 2 shows growth phenotypes of hydroponic rice after addition of 4,5-dimethylthiazole at different concentrations. japonica represents japonica rice (Nipponbare), indica represents indica rice (Heliangyou 332), and C₀, C₅, C₁₀, C₂₀, and C₅₀ represent 4,5-dimethylthiazole addition concentrations of 0, 5, 10, 20 and 50 mg/L, respectively.

FIG. 3 shows influences of different concentrations of 4,5-dimethylthiazole on nitrogen uptake of hydroponic rice.

FIG. 4 shows influences of seed soaking with different concentrations of 4,5-dimethylthiazole on rice seedling growth.

FIG. 5 shows influences of drenching concentration and frequency of different concentrations of 4,5-dimethylthiazole on rice seedling growth.

### DETAILED DESCRIPTION OF EMBODIMENTS

### Example 1: Addition of 4,5-Dimethylthiazole in Promoting Hydroponic Rice Growth and Nitrogen Utilization

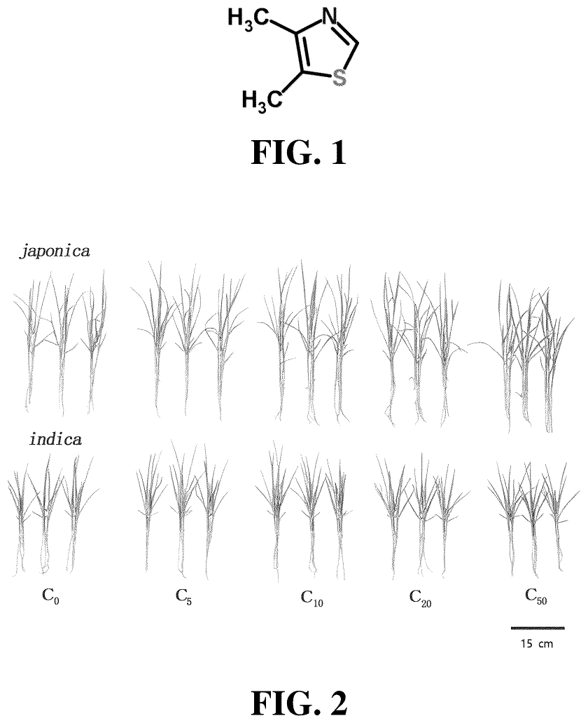

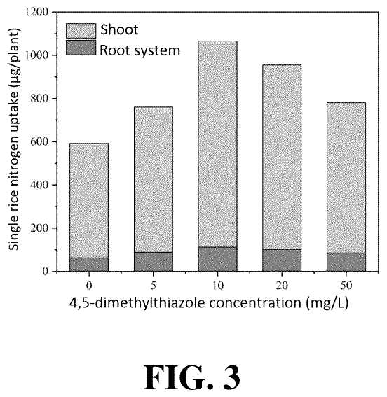

Five addition concentrations of 4,5-dimethylthiazole (CAS No. 3581-91-7, see FIG. 1 for structural formula) were set, being 0, 5, 10, 20 and 50 mg/L, respectively, and a solvent was a rice nutrient solution. Two rice varieties were indica (Heliangyou 332) and japonica (Nipponbare), respectively. The rice was subjected to normal seed soaking, sowing and cultivation. When grown to one leaf and one tiller, rice seedlings were cultivated with mixed solution. Samples were collected after 25 days of cultivation. 30 plants were sampled from each treatment, where 15 plants were divided into two parts of stems and leaves, and root system, which were dried and weighed, and the other 15 plants were measured for agronomic traits. The results indicate that addition of 4.5-dimethylthiazole could promote accumulation of dry matter mass of rice and increase various agronomic trait parameters of rice (FIG. 2 and Table 1). Within a concentration range of 5-50 mg/L, 4.5-dimethylthiazole could increase the dry matter mass of rice shoot part by 25.9%-80.2%, the dry matter mass of root system by 30.2%-71.7%, and the total dry matter mass by 27.0%-78.9%, and increase rice plant height by an average of 31.5%, leaf length by 33.9%, leaf width by 19.6%, leaf area by 59.6% and total root count by 47.8%. In addition, 4.5-dimethylthiazole increased a nitrogen accumulation amount in rice root system and shoot part by 36.6%-79.3% and 26.9%-80.0%, respectively (FIG. 3).

TABLE 1
Influence of Different Concentrations of 4,5-Dimethylthiazole
on Hydroponic Rice Seedling Growth

| | Dry Matter Mass of Rice | | | | | | | |
|---|---|---|---|---|---|---|---|---|
| | (mg/plant) | | | Plant | Leaf | Leaf | Leaf | Total Root |
| Concentration | Shoot | Root | | Height | Length | Width | Area | Count |
| (mg/L) | Part | System | Total | (cm) | (cm) | (cm) | (cm²) | (count/plant) |
| 0 | 13.5 | 2.3 | 15.8 | 12.17 | 7.83 | 0.30 | 1.97 | 5.8 |
| 5 | 17.0 | 3.1 | 20.1 | 16.73 | 10.73 | 0.38 | 3.39 | 8.0 |
| 10 | 24.3 | 4.0 | 28.3 | 16.97 | 10.88 | 0.34 | 3.03 | 8.0 |
| 20 | 22.0 | 3.8 | 25.8 | 16.13 | 11.08 | 0.34 | 3.16 | 8.7 |
| 50 | 19.7 | 3.0 | 22.7 | 14.15 | 9.23 | 0.39 | 3.01 | 9.3 |

### Example 2: Influence of 4,5-Dimethylthiazole Seed Soaking on Rice Growth

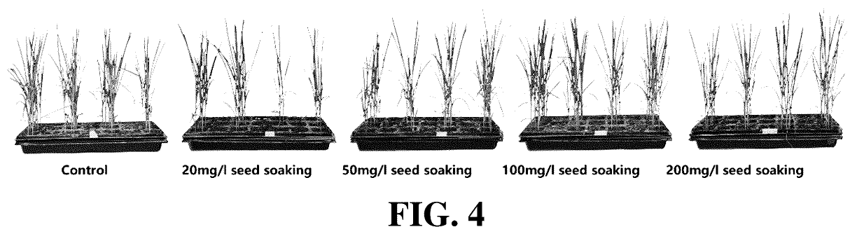

4,5-dimethylthiazole of different weights were dissolved in distilled water to obtain seed soaking agents. Taking seed soaking with distilled water as a control, four seed soaking concentrations (0, 50, 100 and 200 mg/L) were set. Plump and healthy rice seeds (Heliangyou 332) were selected and sterilized with 0.5% sodium hypochlorite for 30 min, and then each seed soaking agent was added in a mass ratio of the seed soaking agent to seed of 1:20. The seeds were soaked in darkness under 28-30° C. condition for 48 h until radicle emergence. The seed soaking solutions were changed every 12 h. Rice substrate soil was loaded 2 cm away from a seedling tray opening, gently compacted, and watered with pure water to be wet. A rice seedling nursery substrate was “rice seedling nursery substrate” purchased from Guangzhou Shengsheng Agriculture Co., Ltd., with main ingredients including peat, vermiculite and yellow mud. Two seeds were sowed in each hole on a substrate surface, covered with the substrate soil again to the seedling tray opening, and watered to be wet. After 30 days of seedling cultivation, nine rice samples were taken from each treatment, divided into shoot parts and root system, which were dried and then weighed; and leaves were taken from another nine rice plants to measure chlorophyll content. The results indicate that the seed soaking with 4,5-dimethylthiazole significantly promoted the growth of rice seedlings (FIG. 4). Compared with the seed soaking with pure water, seed soaking with 50-200 mg/L 4,5-dimethylthiazole could elevate the biomass of shoot parts of rice by 32.3%-32.9%, root biomass by 42.9%-58.2%, total biomass by 31.0%-34.0%, and total leaf chlorophyll content by 6.7%-9.3%. Regarding the biomass of the shoot parts and the chlorophyll content, the seed soaking concentration 50 mg/L rendered the best effect (Table 2).

TABLE 2
Influence of Seed Soaking with Different Concentrations of 4,5-Dimethylthiazole
on Dry Matter Mass and Chlorophyll Content of Rice

| | | | | | | | Total Chlorophyll | |
|---|---|---|---|---|---|---|---|---|
| | Shoot Part | | Root System | | Total | | Content | |
| | | Relative | | Relative | | Relative | | Relative |
| Concentration | Biomass | Value | Biomass | Value | Biomass | Value | Content | Value |
| (mg/L) | (mg/plant) | (%) | (mg/plant) | (%) | (mg/plant) | (%) | (mg/g) | (%) |
| 0 | 61.0 | / | 5.5 | / | 66.5 | / | 3.73 | / |
| 50 | 80.7 | 32.3 | 8.3 | 52.6 | 89.1 | 34.0 | 4.08 | 9.3 |
| 100 | 78.4 | 28.5 | 8.6 | 58.2 | 87.1 | 31.0 | 3.98 | 6.7 |
| 200 | 81.1 | 32.9 | 7.8 | 42.9 | 88.9 | 33.7 | 3.99 | 7.0 |

### Example 3: Influence of 4,5-Dimethylthiazole Root Drenching on Rice Growth

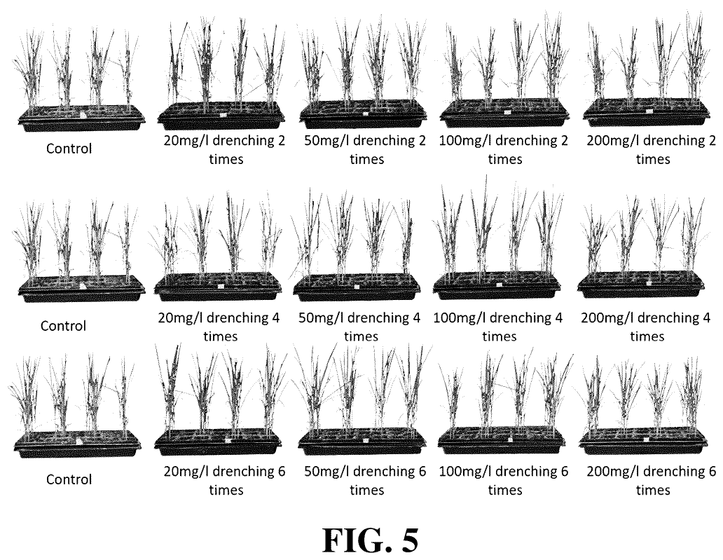

Five root irrigation solution concentrations (0, 20, 50, 100 and 200 mg/L) and three types of root drenching frequency (2, 4, and 6 times) were set. 4,5-dimethylthiazole of different mass was dissolved in distilled water to obtain root irrigation solutions at different concentrations. After normal rice seed soaking and accelerated germination, rice substrate soil was loaded 2 cm away from a seedling tray opening, gently compacted, and watered with pure water to be wet. A rice seedling nursery substrate was “rice seedling nursery substrate” purchased from Guangzhou Shengsheng Agriculture Co., Ltd., with main ingredients including peat, vermiculite and yellow mud. Two seeds were sowed in each hole on a substrate surface, covered with the substrate soil again to the seedling tray opening, and watered to be wet. Three days after the rice seedling emergence, the root irrigation solutions at different concentrations was applied once every five days, until there was a water layer of 5 mm on a surface of the substrate. Each treatment was applied with a consistent amount. The drenching was conducted during cooler evening hours to minimize evaporation. After 30 days of seedling cultivation, nine rice samples were taken from each treatment, divided into shoot parts and root system, which were dried and then weighed; and leaves were taken from another nine rice plants to measure chlorophyll content. The results indicate that the root drenching concentration and frequency significantly affected the growth of rice seedlings (FIG. 5), where 20-200 mg/L 4,5-dimethylthiazole drenching could increase the biomass of shoot parts of rice by 3.1%-40.6%, root system biomass by 16.6%-52.2%, total biomass by 4.1%-41.0%, and total leaf chlorophyll content by 1.6%-27.8% (FIG. 3).

TABLE 3
Influence of Root Drenching with Different Concentrations of 4,5-Dimethylthiazole
on Dry Matter Mass and Chlorophyll Content of Rice

| | | | | | | | | Total Chlorophyll | |
|---|---|---|---|---|---|---|---|---|---|
| | | Shoot Part | | Root System | | Total | | Content | |
| | Treatment | | Relative | | Relative | | Relative | | Relative |
| Drenching | Concentration | Biomass | Value | Biomass | Value | Biomass | Value | Content | Value |
| Time | (mg/L) | (mg/plant) | (%) | (mg/plant) | (%) | (mg/plant) | (%) | (mg/g) | (%) |
| Control | 0 | 61.0 | / | 5.5 | / | 66.5 | / | 3.73 | / |
| 2 Times | 20 | 82.9 | 35.9 | 7.5 | 36.8 | 90.4 | 36.0 | 4.77 | 27.8 |
| | 50 | 79.8 | 30.8 | 8.0 | 46.7 | 87.9 | 32.1 | 4.29 | 15.0 |
| | 100 | 76.3 | 25.0 | 8.3 | 52.2 | 84.6 | 27.2 | 3.82 | 2.5 |
| | 200 | 62.9 | 3.1 | 6.3 | 15.6 | 69.2 | 4.1 | 4.51 | 20.8 |
| 4 Times | 20 | 74.5 | 22.1 | 7.0 | 27.7 | 81.5 | 22.6 | 4.15 | 11.2 |
| | 50 | 79.9 | 30.9 | 8.0 | 46.3 | 87.9 | 32.2 | 4.09 | 9.8 |
| | 100 | 79.6 | 30.4 | 7.7 | 41.6 | 87.3 | 31.3 | 3.82 | 2.3 |
| | 200 | 70.1 | 14.8 | 5.4 | −0.7 | 75.5 | 13.6 | 3.89 | 4.2 |
| 6 Times | 20 | 82.7 | 35.4 | 8.6 | 51.8 | 91.3 | 37.3 | 4.03 | 8.1 |
| | 50 | 85.8 | 40.6 | 7.9 | 44.7 | 93.7 | 41.0 | 4.32 | 15.9 |
| | 100 | 74.7 | 22.4 | 7.1 | 30.2 | 81.8 | 23.1 | 4.20 | 12.7 |
| | 200 | 63.5 | 4.1 | 7.1 | 29.7 | 70.6 | 6.2 | 3.79 | 1.6 |

The present disclosure can also achieve growth-promoting effects on other crops, including, but not limited to, wheat, corn, soybean, sesame, cotton, potatoes, etc.

Although the present disclosure is described in detail in the above examples, they are only some but not all examples of the present disclosure. Other examples could be further obtained according to the examples without using inventive efforts, and these examples all fall within the scope of protection of the present disclosure.

1. Use of 4,5-dimethylthiazole in promoting plant growth.

2. The use according to claim 1, wherein the plant is rice.

3. The use according to claim 2, wherein 4,5-dimethylthiazole is used as a rice seed soaking agent at a concentration of 50-200 mg/L.

4. The use according to claim 2, wherein 4,5-dimethylthiazole is used as a rice root irrigation solution at a concentration of 50-200 mg/L.

5. The use according to claim 2, wherein 4,5-dimethylthiazole is used as a rice hydroponic additive at a concentration of 5-50 mg/L.

6. A method for promoting plant growth, comprising applying 4,5-dimethylthiazole to the plant.

7. The method according to claim 6, wherein the plant is rice.

8. The method according to claim 7, wherein 4,5-dimethylthiazole is used as a rice seed soaking agent at a concentration of 50-200 mg/L.

9. The method according to claim 7, wherein 4,5-dimethylthiazole is used as a rice root irrigation solution at a concentration of 50-200 mg/L.

10. The method according to claim 7, wherein 4,5-dimethylthiazole is used as a rice hydroponic additive at a concentration of 5-50 mg/L.

11. The use according to claim 1, wherein the plant is any one of wheat, corn, soybean, sesame, cotton, and potato.

12. The method according to claim 6, wherein the plant is any one of wheat, corn, soybean, sesame, cotton, and potato.
